(19) United States
(12) Patent Application Publication
(10) Pub. No.: US 2018/0077681 A1
(43) Pub. Date: Mar. 15, 2018

(54) METHOD AND APPARATUS FOR PAGING AN APPLICATION ON A USER EQUIPMENT

(71) Applicants: Philippe LEROUX, Ottawa (CA); Aaron James CALLARD, Ottawa (CA)

(72) Inventors: Philippe LEROUX, Ottawa (CA); Aaron James CALLARD, Ottawa (CA)

(73) Assignee: Huawei Technologies Co., Ltd., Shenzhen (CN)

(21) Appl. No.: 15/617,695

(22) Filed: Jun. 8, 2017

Related U.S. Application Data
(60) Provisional application No. 62/395,166, filed on Sep. 15, 2016.

(51) Int. Cl. H04W 68/02; H04W 4/14

(52) U.S. Cl. CPC H04W 68/02; H04W 88/02; H04W 4/14

(57) ABSTRACT

A method and apparatus for paging an application on a User Equipment, UE are disclosed. When an application server is to push a notification or other data to an application operating on the UE, the application server transmits a paging notification for transmission to the UE. Prior to the transmission of a paging notification by the application server, the application provides an identifier to the application server, wherein the identifier includes at least some details relating to the application and the associated UE. The identifier can be used by communication mechanisms intermediate between the application server and the UE to direct the paging notification to the UE with which the intended application is associated. According to embodiments, the paging notification can be configured such that a locator function, which may operate in a manner similar to a Domain Name Service (DNS) server, can determine the operator network which provides communication connectivity to the UE. The operator network can subsequently be instructed to transmit a suitable paging notification to the UE. In some embodiments, the paging notification is configured as a Short Message Service (SMS) which is directed to the UE.

### CROSS-REFERENCE TO RELATED APPLICATIONS

This application claims the benefit of U.S. Provisional Application Ser. No. 62/395,166 titled “Method and Apparatus for Paging an Application on a User Equipment” filed on Sep. 15, 2016, which is incorporated by reference herein in its entirety.

### FIELD OF THE INVENTION

The present invention pertains to the field of communication networks and in particular to a method and apparatus for paging an application on a user equipment (UE) or other such electronic device (ED).

### BACKGROUND

An application server can be required to contact an application operating on a user equipment (UE) to support for example, WebPush or other notification mechanisms. For example, WebPush can be used to push new email to a mail application operating on the UE. Push-based messaging allows a server to transmit data to a UE, without the UE initiating a transmission. An alternative to Push-based messaging is having the UE check the server to see if there is new data available, which is referred to as UE-based polling. Push-based messaging is popular because it provides immediate access to messages and data, where polling typically introduces an additional latency into messaging. Push-based messaging can encounter latency when provided in an IP-based or mobile environment. Firewalls can prevent application servers from initiating sessions (such as HTTP(s) sessions) with a UE and the applications resident upon the UE. Additionally, a UE can have reception problems when mobile if there is a change to the internet protocol (IP) address associated with the mobile UE. To address these issues, and provide push-like functionality, many application servers (AS) employ long polling. In a long poll, a UE initiates a poll request with the AS, but specifies a long interval for the timeout value. This allows the AS to leave the logical connection alive and transmit a response to the UE when new data is available. If no data arrives within the timeout window, the connection is terminated by the timeout, and the UE can initiate a new long poll.

As noted above, polling methods (and associated keep alive messaging) are employed to support application server initiated transmissions to a UE. However a consequence of this strategy is that it generates substantial traffic and overhead signalling. Additional, it prevents UEs from remaining in idle mode by forcing the UEs to periodically reattach to the network to transmit keep alive messaging. The network overhead is both in the transmission of long poll requests that are allowed to expire, and in the signalling required for the UE to reattach just to transmit a long poll request. The less frequently data arrives at the AS for delivery to the UE, the greater the percentage of overall local network traffic that can be attributed to the signalling overhead.

Therefore there is a need for a method and apparatus which enables an application server to contact a user equipment that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for paging an application on a user equipment or electronic device. In accordance with an aspect of the present invention, there is provided a method for paging an application operating on (or associated with) a user equipment (UE) or electronic device (ED). The method includes transmitting, by the UE, an identifier, the identifier at least indicative of the application and receiving, by the UE, a notification, the notification including data indicative of the identifier. In addition, the method includes determining, by the UE, if the notification is a paging notification and identifying the application associated with the identifier when the notification is a paging notification.

In accordance with another aspect of the present invention, there is provided a method for paging an application operating on a UE or ED. The method includes receiving, by an application server, an identifier, the identifier at least indicative of the application and transmitting, by the application server, a paging notification, the paging notification including data indicative of the identifier.

According to embodiments, the paging notification is transmitted as a short message service (SMS) message. According to embodiments, the paging notification is transmitted to a locator function configured to locate the UE.

In accordance with another aspect of the present invention, there is provided a method for paging an application operating on or associated with a UE or ED. The method includes receiving, by a network based locator function which may be instantiated upon a network node, an identifier, the identifier at least indicative of the application and the UE. The method further includes determining, by the network based locator function or network node, one or more mobility managers which serve the UE, wherein determining is based at least in part on the identifier. In addition, the method includes transmitting, by the network based locator function or network node, a paging request to the one or more determined mobility managers, the paging request including data indicative of the identifier.

### BRIEF DESCRIPTION OF THE FIGURES

Further features and advantages of the present invention will become apparent from the following detailed description, taken in combination with the appended drawings, in which:

FIG. 1 illustrates methods for paging an application on a UE in accordance with embodiments of the present invention.

FIG. 2 illustrates graphically a communication path from the application server to the UE in accordance with embodiments of the present invention.

FIG. 3 illustrates graphically a communication path from the application operating on the UE to the application server upon triggering by a paging notification in accordance with embodiments of the present invention.

FIG. 4 illustrates a method of accessing the operator network for initiating paging of a UE in accordance with embodiments of the present invention.

FIG. 5 illustrates a method of paging an application operating on a UE in accordance with embodiments of the present invention.

FIG. 6 illustrates a method of paging a UE using a SMS message in accordance with embodiments of the present invention.

FIG. 7 illustrates a signalling diagram for a method of paging an application operating on a UE in accordance with embodiments of the present invention.

FIG. 8 illustrates a signalling diagram for a method of paging an application operating on a UE in accordance with embodiments of the present invention.

FIG. 9 is a schematic diagram of a hardware device, accordance with embodiments of the present invention.

It will be noted that throughout the appended drawings, like features are identified by like reference numerals.

### DETAILED DESCRIPTION OF THE INVENTION

The present invention provides a method and apparatus for paging an application on a UE or ED. According to embodiments, the application server initiates an application paging notification process on an as needed basis for initiating contact with an application operating on a UE. As such, an application operating on the UE does not maintain a connection or defined connection path with the application server, thereby mitigating the required overhead signalling and keep alive messages.

According to the instant application, when an application server is to push a notification or other data to an application operating on the UE, the application server transmits an application paging notification, for transmission to the UE. Prior to the transmission of an application paging notification by the application server, the application at the UE can provide an identifier to the application server. The identifier includes details relating to the application and the associated UE. The identifier can be used by communication nodes and functions, located between the application server and the UE, to direct the application paging notification to the relevant UE. According to embodiments, the identifier is further used for directing the application paging notification to the desired application operating on the UE

According to embodiments, the application paging notification can use a locator function, which may operate in a manner similar to a domain name service (DNS) server. The DNS-like locator function (LF) can be used to communicate with the operator network which provides communication connectivity to the UE. The operator network can subsequently be instructed to transmit a suitable paging notification to the UE. For example a suitable paging notification can include a portion of the application paging notification, which may enable the application to identify the application server which is the origin of the application paging notification. According to some embodiments, a suitable paging notification can include a portion of the application paging notification, which may enable the application to identify and authenticate or validate the origin of the application paging notification. According to embodiments, the locator function is operating on a network node. It should be understood that in some situations, a UE may not be on a home network, and may be roaming on a different network. The LF can, in some embodiments, make use of operator specific information to determine the visiting network through which the UE is connected, while in other embodiments, the home network can forward information to the visiting network on behalf of the AS.

In some embodiments, the application paging notification can be configured to resemble a short message service (SMS) message which is directed to the UE. In other embodiments the application paging notification can be transmitted using the SMS system which it typically already present in a network. This application paging notification can include information indicative of the identifier. Upon receipt of the application paging notification, which may resemble a SMS message, the UE can determine the application with which the application paging notification is associated. By configuring the SMS-like message associated the application paging notification to have a defined structure (or a parsable structure), the UE can determine the application in accordance with the SMS-like message. For example, the determined application can be the intended target of the application paging notification. The AS or application can be identified in the SMS-like message associated with the application paging notification, and may be identified by a sending or sender's address. For example the sender's address can be associated with the SMS-like message. If the identified application is operating, the application paging notification can be forwarded to the application through the UE operating system. If the identified application is not operating on the UE, in some embodiments, the UE may launch the appropriate application and forward the application paging notification to the identified application. It would be understood that the forwarding of the SMS-like message associated with the application paging notification may in fact be forwarded after determining that the launched application is sufficiently responsive.

According to embodiments, the application paging notification includes data which results in the application performing one or more desired actions. For example the data associated with the application paging notification, upon inspection by the application, can cause the application to initiate a connection with the application server, perform a function, display particular data to the user, store the message for later use, acknowledge the function status of the application or perform another action as would be readily understood by a worker skilled in the art.

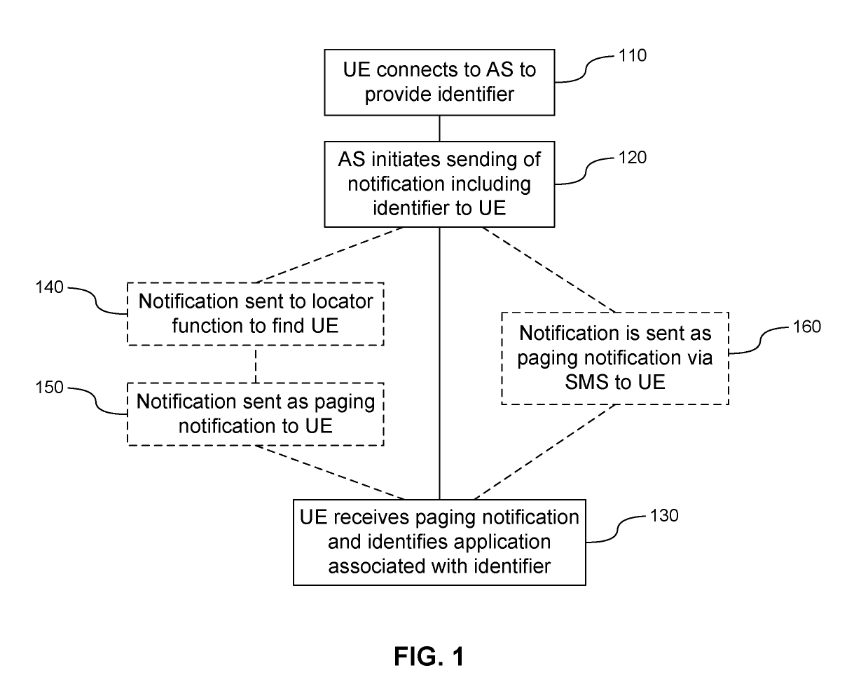

FIG. 1 illustrates methods for paging an application on a UE according to embodiments of the present invention. Prior to any action taken by the application server, the UE connects with the application server to provide an identifier 110. At a time when notification of the application is required, for example when a new email has been received by the application server which is for an application on a UE, the application server initiates a notification process which includes transmitting an application paging notification 120. The application paging notification can include an identifier with sufficient information to identify the application and the UE with which the application is associated. In some embodiments, the AS sends the application paging notification as an SMS addressed to the UE 160. The SMS based notification can be configured as an application paging notification and include the application identifier. In other embodiments, the application paging notification can be sent to a locator function 140, for example a locator server which may be similar in operation to a DNS server. The Locator Function can be configured to determine the operator network to which the UE having the application thereon is connected. An entity within the operator network can then be instructed to send a notification as a paging notification to the UE 150, wherein the paging notification includes the identifier. In each case, upon the UE receiving the paging notification the UE proceeds to identify the application operating thereon that is associated with the identifier 130. For example the identifier can be included in the paging notification. The UE subsequently, for example via the operating system (OS), relays the paging notification to the appropriate application.

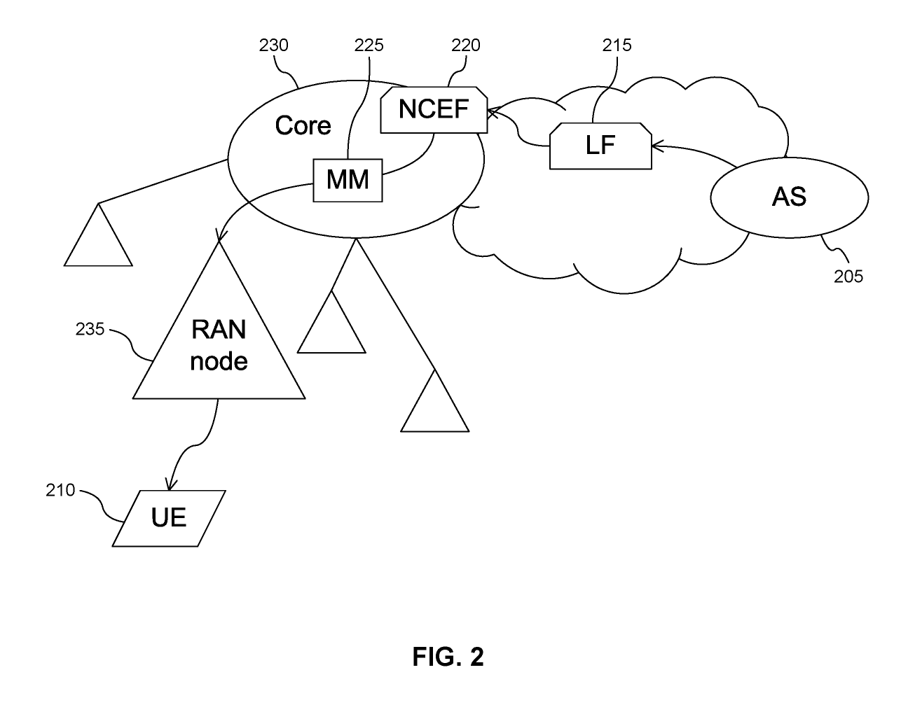

FIG. 2 illustrates graphically a communication path from the application server 205 to the UE 210 in accordance with embodiments of the present invention. The application server sends an application paging notification to a locator function 215 in order to determine an operator network that provides communication services to the UE associated with the and application desired for contact. The locator function can use for example a lookup type function or other process in order to determine the required operator network. The locator function can be instantiated in the format of a DNS server type configuration. The locator function contacts a network capability exposure function (NCEF) 220 associated with the core network of the identified operator network. In some embodiments, the role of the NCEF may be performed by other network functions such as a Service Capability Exposure Function (SCEF), or a Network Exposure Function (NEF). The NCEF can communicate with a mobility manager (MM) 225 within the core network 230 to request the paging of the desired UE. In some embodiments, the MM 225 may be a network function such as an Access and Mobility Function (AMF). In this way the UE and application associated with the identifier that was originally provided by the application server, can be paged by the MM. According to embodiments, the transmission path or communication path can pass through a single network capability exposure function (NCEF) or a combination of NCEFs which operate together to provide the required network functionality. According to embodiments, a NCEF can be at least in part the same as a 3GPP service capability exposure function, (SCEF).

With further reference to FIG. 2, in embodiments where the desired UE 210 is in an active state, the MM 225 can determine the suitable radio access node (RAN) 235 (or nodes) currently providing service to the UE. The access node can be instructed to send an application paging notification to the UE along with the identifier. However in embodiments where the desired UE is in an idle state, the MM can proceed to send a paging notification, which can be similar to an LTE or other standardized paging notification, to one or more radio access nodes (RAN) of a tracking area (TA) associated with the idle UE. The paging notification sent by the MM can be configured to include the specific data associated with application paging notification or the paging notification sent by the MM can be configured to instruct the UE to transition to an active state so that it can receive the application paging notification. The application paging notification transmitted to the UE, can include information indicative of the identifier. In addition, when the paging notification sent by the MM includes the application paging notification or is indicative of the application paging notification, the UE can act upon the application paging notification in an appropriate manner without necessarily having to transition to a fully active state. As would be readily understood, acting upon the application paging notification without transitioning into an active state implies that the action or actions to be taken by the UE or application associated with the UE, can be performed without the UE being in a fully active state.

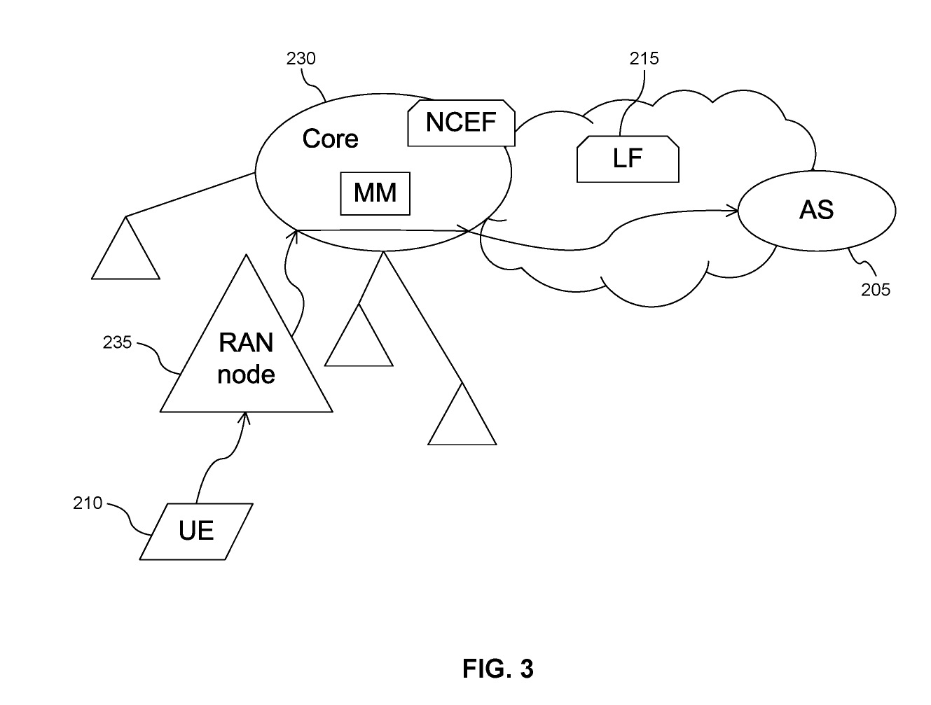

FIG. 3 illustrates graphically a communication path from the application operating on the UE 210 to the application server upon triggering by a paging notification in accordance with embodiments of the present invention. In some instances the application paging notification received by the UE causes the UE to reactivate a communication session with the application server 205 which initiated the application paging notification. In some embodiments, the UE can transfer from an idle state to an active state and subsequently commence a transport control protocol (TCP) session for communication with the application server. In other embodiments, when the UE is already in an active state, the UE may merely commence a TCP session with the application server 205. In other embodiments, the application can interpret the application paging notification and not initiate establishment of a session to the application server, and subsequently notify the UE to remain in the idle state. According to embodiments, the establishment of a session between the UE and the application server can be established in a simple manner as the UE 210 can determine the identity of the application server 205 with which it is to communicate from the application paging notification,. For example, the UE 210 contacts the RAN 235 providing it with network connectivity to the core network 230 of the operator network and a communication session can subsequently be established between the UE 210 and the application server 205. In another embodiment, the establishment of a session between the application and in particular the UE upon which the application is operating and the application server is achieved or routed via the locator function 215 which acts as a relay for the application paging notification from the application server and the response for the application operating on the UE.

In some embodiments, the UE is configured to evaluate the responsiveness of the application and in some instances the UE is configured to reply to the application server in order to inform the application server of the status of the UE or status of the application operating on the UE or both. The initiation of this type of reply can be based on the configuration of the UE or may be in response to a reply request included in the application paging notification. In addition, according to embodiments, the UE is configured to provide feedback within a response to the RAN paging of the UE, using for example a Zadov-Chu sequence on a predefined channel or an uplink transmission grant provided within the paging information. The RAN can forward this reply to the application server without requiring the UE to establish a communication session with the application server.

In some embodiments, additional security, for example in the form of a token or content data, may be resubmitted by the UE for reactivation of a previously paused communication session. This additional security can provide authorization and re-establish authentication for restoration of a TCP session between the application server and UE that was previously in use. In some embodiments, additional security can be configured as a token provided by the application server in the application paging notification. In this embodiments, the UE's application can be able to validate and certify an application paging notification as an authentic application paging notification originating from the application server.

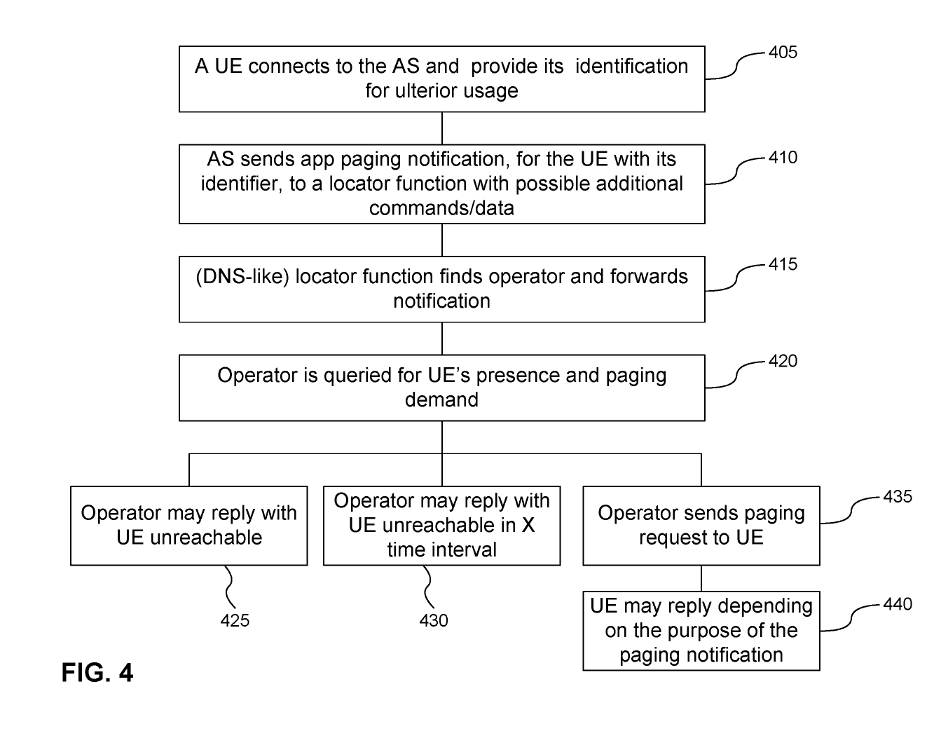

FIG. 4 illustrates a method of accessing the operator network for initiating paging of a UE in accordance with embodiments of the present invention. Initially, a UE connects 405 with the application server and provides the identification of the UE and application operating thereon, for example the UE can provide the application server with an identifier, wherein this identifier can be used by the application server at a later time for establishing or re-establishing a communication session with the UE. When the application server requires a communication session with the UE, the application server sends 410 a paging request, for example an application paging notification, to a locator function, for example a locator server. According to embodiments, the application paging notification can include the identifier associated with the application. In some embodiments, the paging request or application paging notification includes additional commands and/or data which is to be included in the paging request to be sent to the UE. The locator function identifies 415 the operator network that is currently providing communication with the UE, and initiates a paging request be sent by the operator network for the UE. As noted above, the locator function may be similar to a domain name server in structure and operation. The paging request may include additional commands and/or data. The operator network can query the MM to determine the UE's presence or current operational status, for example is the UE in an idle state or an active state. A network function within the operator network can also send a paging demand. In some embodiments, the paging demand can include at least an indication of a purpose of the initiation of the application paging notification by the AS. In other embodiments it will be understood that the paging demand may be referred to by other terms such as paging request or request for paging. In some embodiments, the operator network responds to the paging request with a response that defines the UE as being unreachable 425, for example the UE is not responding to a page or out of range of the operator network. In some embodiments, the operator network responds to the paging request with a response that the UE is reachable in a defined amount of time 430. For example, this defined amount of time can be related to the discontinuous reception (DRX) cycle of the UE, which is indicative of periodic checks by the UE for communication session requests, when the UE is placed in a power saving mode. In some embodiments, when the operator network determines that the UE is operable, the operator network can send the paging request or application paging notification to the UE 435 and the UE can reply 440 to this paging request depending on the purpose of the paging request. The operator network can send the paging request via the RAN node that is providing communication network connectivity to the UE. For example, the paging request can include a command to instruct the application operating on the UE to contact a particular application server in order to obtain a pending notification or the paging request can include data which is to be acted upon by the particular application operating on the UE.

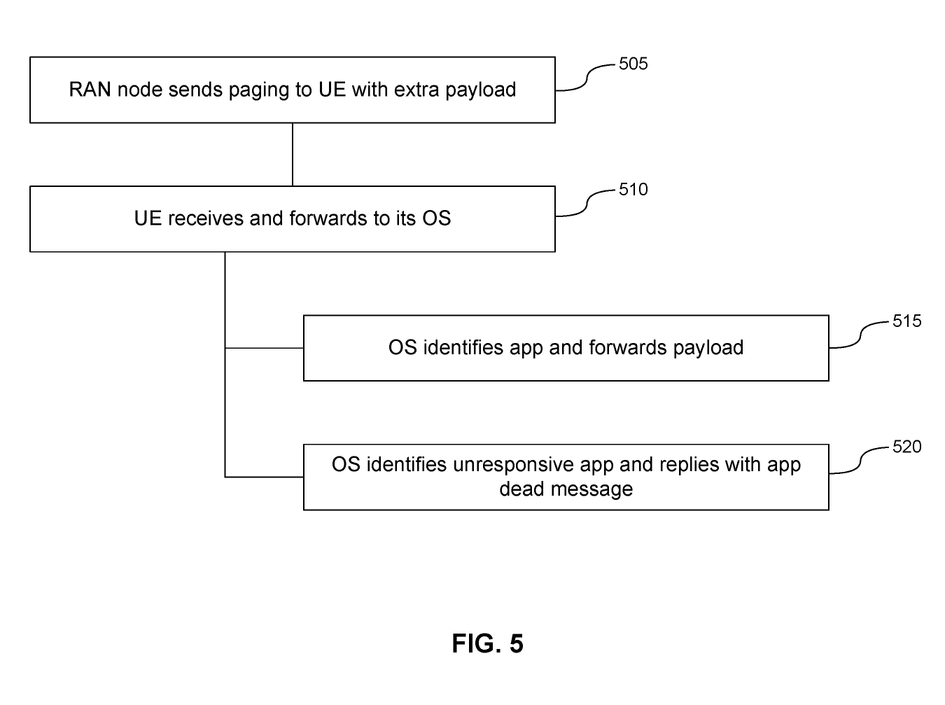

FIG. 5 illustrates a method of paging an application operating on a UE, in accordance with embodiments of the present invention. The operator network determined to be serving the UE requested by the application server, can transfer, or transmit, a paging request or application paging notification to the RAN node that is providing communication connectivity to this UE. The RAN node can send 505 the paging request to the UE, along with an extra payload, for example one or more commands or data. According to embodiments, the payload can be indicative of application paging notification, the identifier associated with the application, instructions regarding a task to be performed by the UE or the application operating on the UE, or other type of data or commands as would be readily understood. In some embodiments, this payload is indicative of the application that is requested to initiate or re-establish a communication session with the application server. The UE receives 510 the paging request and subsequently forwards this request to the operating system (OS) thereof. The OS subsequently identifies the requested application from the paging request and the OS will determine the state of the application, for example operative or inoperative. If the application is operative, the OS can forward 515 the payload to the application for the application to subsequently act upon. If the application is inoperative 520, the OS can respond to the UE with an appropriate message which may be relayed by the UE back to the application server, via the communication network. For example the OS may respond to the paging request with an application dead message, wherein this type of response from the OS, upon receipt of an indication of same by the application server, may cause the application server to update the designated status of that application for future consideration.

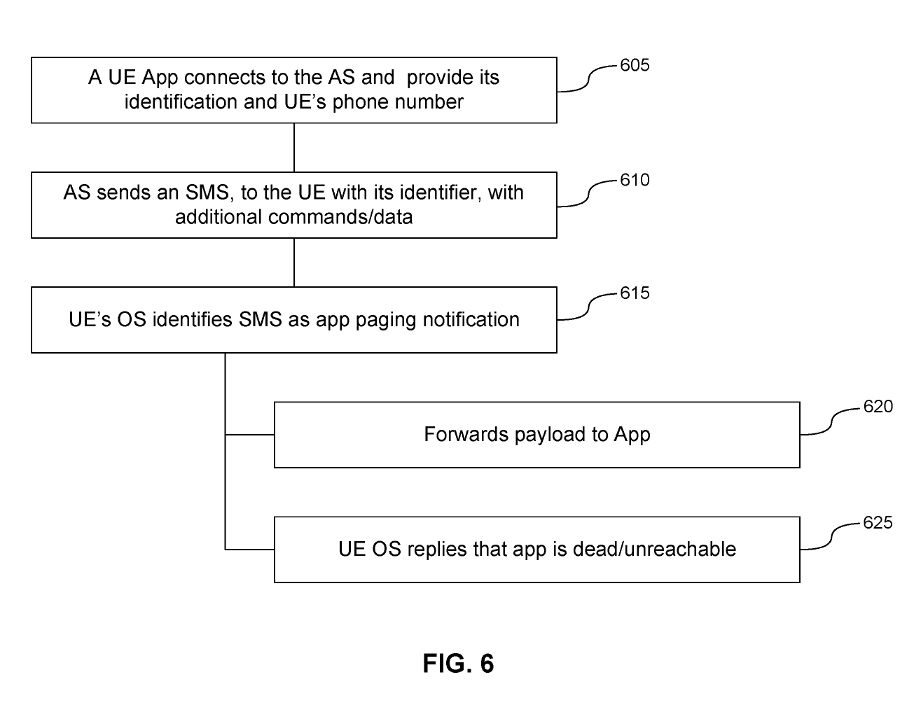

FIG. 6 illustrates a method of paging a UE using SMS in accordance with embodiments of the present invention. Initially, a UE connects 605 with the application server and provides the identification of the UE and application operating thereon, for example the UE can provide the application server with an identifier, wherein this identifier can be used by the application server at a later time for establishing or re-establishing a communication session with the UE. The application server configures a SMS message for transmission 610 to the UE wherein this SMS message includes the identifier previously provided to the application server, and in some instances the SMS can include a payload in the form of additional commands and/or data. It will be understood that the message may also include an identifier associated with the application or the application server. According to embodiments, the payload can be indicative of application paging notification, the identifier associated with the application, instructions regarding a task to be performed by the UE or the application operating on the UE, or other type of data or commands as would be readily understood. The application server subsequently sends this SMS message to the UE. The UE receives the SMS message and the OS of the UE evaluates 615 the SMS message in order to determine if this SMS message is a paging notification. If the SMS message is determined to be a paging notification, the application associated with the notification is identified. The OS can then determine the state of the application, for example operative or inoperative. If the application is operative, the OS can forward 620 the payload to the application for the application to subsequently act upon. If the application is inoperative, the OS can respond 625 to the UE with an appropriate message which may be relayed by the UE back to the application server, via a communication network. For example the OS may respond to the paging request with an application dead message, wherein this type of response from the OS, upon receipt of an indication of same by the application server, may cause the application server to update the designated status of that application for future consideration.

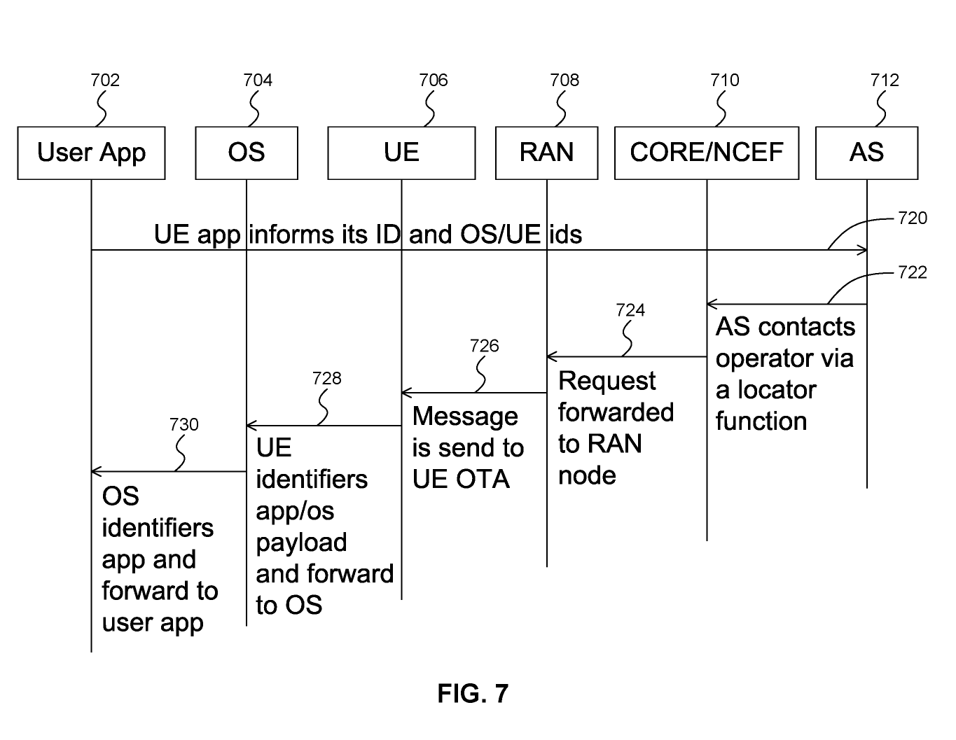

FIG. 7 illustrates a signalling diagram for a method of paging an application operating on a UE in accordance with embodiments of the present invention. Initially, a UE 706 connects with the application server 712 and provides 720 the identification of the UE and application 702 operating thereon, for example the UE can provide the application server with an identifier, wherein this identifier can be used by the application server at a later time for establishing or re-establishing a communication session with the UE. Those skilled in the art will appreciate that the identifier provided to the AS may be similar to the structure of an Internet domain name, allowing a Locator Function, to provide the AS with the information required to access the NCEF to send the notification message to the UE. When establishing or re-establishing a communication session is required, the application server may contact a locator function which is configured to determine the operator network which is providing communicative interconnectivity to the requested UE. The application server 712 contacts 722 the operator network, namely a function within the core network, such as a network capabilities exposure function (NCEF) 710, requesting that the UE be paged. The NCEF forwards 724 this paging request to the RAN 708 serving the UE, wherein the RAN subsequently sends 726 a paging notification to the UE 706 over the air (OTA) wherein this paging notification includes the identifier and optionally includes additional data and/or commands. According to embodiments, the data and/or commands can be configured as a payload and can be indicative of instructions regarding a task to be performed by the UE or the application operating on the UE, or other type of data or commands as would be readily understood. According to embodiments, the transmission can pass through a single network capability exposure function (NCEF) or a combination of NCEFs which operate together to provide the required network functionality. According to embodiments, a NCEF can be at least in part the same as a 3GPP service capability exposure function, (SCEF).

With further reference to FIG. 7, the UE 706 receives the paging notification, and the UE via the OS identifies the application that is being paged. The payload, which may include the identifier and optionally the additional data and/or commands, is forwarded 728 to the OS which subsequently forwards 730 this identifier and optional additional data and/or commands to the application requested. For example, the paging notification can include a command to instruct the application operating on the UE to contact a particular application server in order to obtain a pending notification or the paging notification can include data which is to be acted upon by the particular application operating on the UE. As would be readily understood by a worker skilled in the art, during the process of the application server paging a particular application operating on a particular UE, the illustrated signalling diagram can include a plurality of acknowledgements/negative acknowledgements being sent between the respective components enabling the transfer of the paging notification. In some embodiments, these acknowledgements and/or negative acknowledgements can be relayed back to the application server.

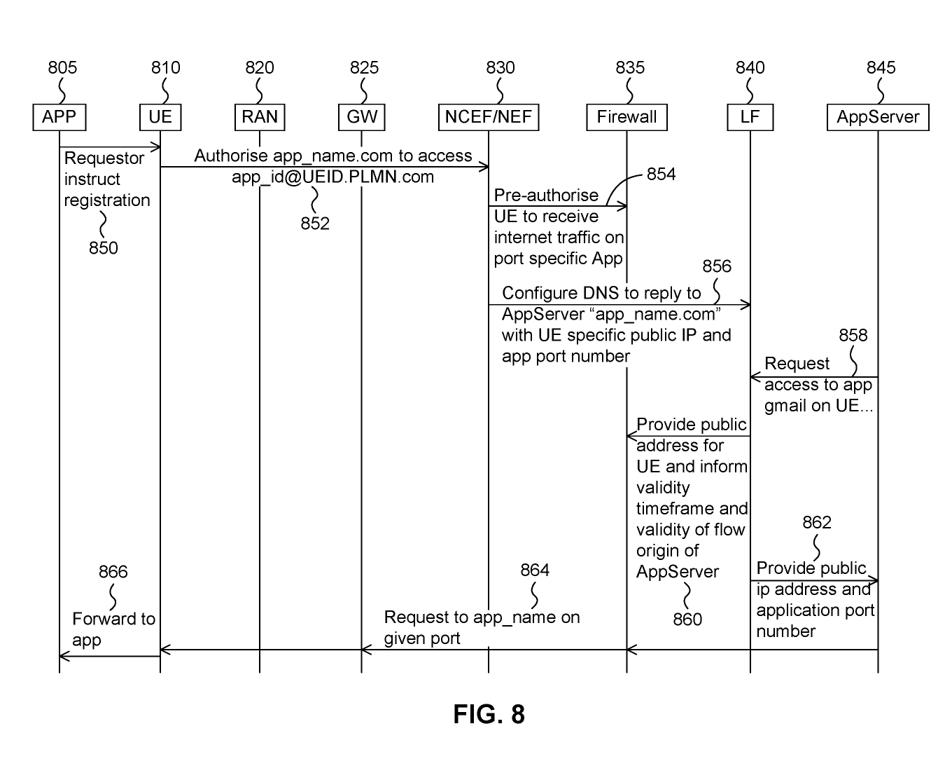

FIG. 8 illustrates a signalling diagram for a method of paging an application operating on a UE in accordance with embodiments of the present invention. This signalling diagram defines a process by which an application operating on a UE, initiates and provides an application server with the required parameters enabling the application server to contact the application. According to embodiments, the UE can further provide authorizations to components of the communication network, for example firewalls and locator function(s) with the necessary authorizations, identifications parameters or both, which can enable the application server to transmit to the application.

Having particular regard to FIG. 8, the application 805 operating on the UE 810 initiates a request or instruction for registration 850 of the application with the application server. The UE 810 sends an authorization message 852 to the NCEF 830 resident on the operator network. As would be understood the UE communicates with the NCEF via a

RAN 820 (or a node within a RAN, such as a base station or other such access node) to which it is communicatively connected and further through a gateway function (GW) 825. In some embodiments, the GW function may be a Packet Gateway (PGW) and in other embodiments it may be a User Plane Gateway (UPGW). According to embodiments, the authorization message 852 includes an indication of the specific application server, for example application_identifier.com, and also an identifier associated with the application resident on the UE. For example, using application_name.com as an example of an application server, the identifier may be configured as:

application_identifier@UEID.PLMN.com,

application_identifier@UEID.carrier_name. com,

UEID.carrier_name.com/application_identifier, ueid.plmn.com: 452, where 452 is representative of a port number associated with the application, or other configuration as would be readily understood. According to some embodiments, the identifier can be configured as a temporary domain name which can be provided by the UE. In some instances this temporary domain name can be valid for a predetermined time. The NCEF 830 can transmit a configuration message to the locator function (LF) 840 such that the LF can provide the application server with location parameters relating to the UE within the network and may provide the application server with specific parameters relating to the application associated with the UE. For example, the NCEF 830 can configure the LF 840 to reply to an application/UE specific request by the application server “application_name. com” with the UE specific IP address and port number associated with the application operating on the UE. As such, upon receipt of a request for access 858 to a particular application operating on a particular UE, the LF can provide 862 the specific IP address associated with the requested UE and the port number associated the particular application resident on that UE. The application server 845 can then use this information to transmit a notification towards the specific application resident on a specific UE 864. The notification transmitted by the application server can include the specific IP address associated with the requested UE and the port number associated the particular application resident on that UE (as provided by LF 840). Upon receipt of this notification by the UE, the UE can subsequently use the identified port number for forwarding 866 this notification to the appropriate application.

With further reference to FIG. 8, in some embodiments, a firewall 835 may be positioned at an intermediate location between the application server and the UE. According to some embodiments, the NCEF 830 can transmit a pre-authorization message 854 to the firewall to instruct the firewall to allow passage therethrough of Internet traffic which is directed to a particular UE (e.g. UE with a particular IP address) and an associated application (e.g. an application with a particular port assigned).

According to some embodiments, when a firewall 835 is positioned at an intermediate location between the application server and the UE, the LF 840 can transmit an authorization 860 to the firewall to allow passage of a transmission from a particular application server to a particular UE. According to some embodiments, this authorization can include a validity time window, wherein during this time window passage of this transmission is allowed and outside of this time window the transmission is denied. According to some embodiments, an authorization to the firewall to allow passage of a transmission from a particular application server to a particular UE may be transmitted to the firewall by a communication network management entity other than the locator function. For example, the authorization can be transmitted to the firewall by the NCEF.

According to embodiments, the method and apparatus for paging an application on a UE can require a standardized, or operator network supported method of initiating the paging by the sending of an application paging notification, for example an application paging notification which includes the application ID. According to embodiments, if the locator function is a DNS server (or a server similar in nature to a DNS server), minimal modification of the DNS server would be required in order to support the required functionality of the locator function, as the functionality of the locator function is similar to the functionality of a DNS server. In some embodiments, the locator function can be configured to use a get/post method on an operator network server, wherein a universal resource locator (URL) is provided.

According to embodiments, when the UE contacts the application server to provide the identifier of the application and UE upon which the application operates, the identifier can include one or a combination of a phone number; MAC address; IMEI; MSIN; operator network information, for example international country code and operator network code; preferred server address to page, for example the operator network's paging server IP address, DNS server name or URL; information indicative of method of access of the application on the UE if this access is not predefined; and OS type of the UE which may identify a method to identify the application operating on the UE.

According to embodiments, when the application server sends a request, for example an application paging notification, to the locator function wherein this request includes the identifier, the application server can additionally send information indicative of the application server's identification which can be transmitted to the UE via the paging notification. For example, the application server can provide one or more of application name or ID on the UE; executable name used in the UE's OS; port number which is configured on the UE to trigger the application or socket information relating to the application; application server IP address or URL; information indicative of the method to access the application server for a reply, for example the TCP port number, HTTP or get/post details; and acceptable latency for the transmission of the paging notification, for example can the transmission of the paging notification be buffered with one or more additional paging notifications.

In some embodiments, the UE provides configuration details to the locator function, wherein these configuration details define how an application paging notification is to be sent to that UE. For example the configuration details can include information indicative of protocol, port number, universal resource locator (URL) or the like or combination thereof. In some embodiments, the locator function is configured to translate the application paging notification into a format that can be received and processed by the UE.

According to embodiments, the locator function can reply with an acknowledgement upon receiving the application paging notification. The locator function may reply with a response that the application paging notification has been rejected. The locator function may reply to the paging notification with additional information if that additional information is available at the time of the sending of the response. In some embodiments, the locator function can respond with information that is indicative of acknowledgement of the request, that the UE is present in the operator network, that the paging notification has been transmitted or that the UE is unreachable, or a combination thereof.

According to embodiments, within the initial paging request or notification transmission or alternately subsequent to the acknowledgment of receipt of the paging request, the application server can send additional information for use by the UE upon receipt of the paging notification. In some embodiments, this additional information can be instructions for the UE to execute a specific command. This specific command may be sent as a specific series of bytes identifying the command as predefined by the application server and the application on the UE. For example, a specific command can be to contact the application server, changes status of the application, change context information which may relate to security or information relating to a previously paused communication session. In some embodiments, the additional information can be instructions to restore a context of a previous connection, for example a URL extension which the UE's end application can use, context identification or a security code for authentication or a coded passphrase or cryptogram. In some embodiments, the additional information can be the form of a notification of new mail and may optionally include a summary of the new mail. In some embodiments, the additional information may be indicative of a delay for validity of the paging notification. For example, if the UE does not answer the paging notification within the defined delay period, a future response from the UE will be dropped or the paging notification will be disregarded.

In some embodiments the UE may use the additional information received in the paging notification to perform one or more additional actions. For example, the UE can use the additional information to verify that the connection, notification or command request is valid and trusted. The UE may use the additional information to compute an answer to enable verification application server upon contact by the application. For example the answer determined by the UE may be indicative of the particular paging notification that triggered the establishment of a communication session by the application. In some embodiments, the additional information in the paging notification can be indicative of the UE's previous context information that may be stored within the UE, thereby enabling verification of the application server by the UE.

In some embodiments, if the OS of the UE is not able to forward the paging notification or payload to the application, the OS can reply to the paging request or notification with an application dead or application unreachable message, which may subsequently be forwarded to the application server. In some embodiments, replies directly to the application server if the additional information includes directives to respond. In some embodiments, the OS of the UE can respond to the application server via the operator network's paging function through the locator function, or via and extended acknowledgement/negative acknowledgement reply to the paging, or a message which identifies the status of the application, or acknowledgement or negative acknowledgement of full delivery of the additional information.

According to embodiments, security of the communication is implicit as it is the operator network that is paging the UE and respective application. However, it is the UE which has to originally register with or contact the application server in order to provide at least the identifier which enables the application server to subsequently contact the UE. As such, in some embodiments, a further layer of security is provided in order for the UE to provide the identifier to the application server. For example, when initially communication with the application server, the UE is required to go through an authentication/authorization process in order to officially register for the paging notification service with the application server. For example, the authentication/authorization may be provided by a service similar to OAuth which is an open standard for authorization for Internet users to log in to third party websites using their Google, Facebook and the like accounts without exposing their password. This type of authorization specifies a process for resource owners to authorize third-party access to their server resources without sharing their credentials.

According to some embodiments, the identifier includes a limited amount of additional information. For example, a portion of the identifier is used to define the application, which an additional portion of the identifier is used to define one or more actions to be taken by the application. As an example the identifier includes a total of 8 bits, 6 bits may be used to define port numbers which may be able to define a total of 64 different applications. The remaining 2 bits can be used to provide one of four action instructions to the application. These four actions may: instruct the application to connect to the application server; inform the application the application of a non urgent notification that can be fetched when the UE is in an active state; instruct the application to take a measurement and store the data; instruct the application to request forwarding of stored data. As would be readily understood, the number of bits used in the identifier can be different and the particular instructions defined by the bits can take a variety of forms.

According to some embodiments, there is a preferential paging method for contacting an application operating on a UE. In some embodiments, there is a preferential order of paging method use for the contacting of an application operating on a UE. The preferential paging method or preferential order of paging method use can be dependent on the application, the UE or the combination of the application. In some embodiments, the identification of a preferential paging method or a preferential order of paging method of use can be associated with the identifier that is provided to the application server by the UE. For example, an application operating on a UE is preferentially contacted by the application server using SMS paging discussed above, and this preferential paging method of contact can be defined by the identifier provided to the application server. As another example, a particular application/UE combination is to be preferentially contacted by the application server using SMS paging, however the same particular application/UE combination may be contacted locator function paging as discussed above. The transition to the locator function paging may occur when the application server is unable to contact the application via SMS paging or unable to contact the application by SMS paging for a predetermined amount of time. It will be readily understood that these are merely examples of a preferential paging method or a preferential order of paging method.

According to embodiments, the paging of the application directly rather than paging the UE, can reduce the number of times that the UE will have to reconnect to the communication network upon receipt of a paging notification. For example, when a UE is paged, it is forced to reconnect to the communication network in order to determine the reason for the receipt of the page notification. By paging the application operating on the UE directly, the UE does not have to reconnect due to the receipt of the paging notification, however the UE will be directed to proceed in a manner that is in line with potential instructions included in the page. For example, the paging notification may instruct the application to perform a particular function that does not require the reconnection of the UE to the communication network.

According to embodiments, the paging notification received by the application, which can include a payload, for example additional information, requires an acknowledgement from the UE to be forwarded or translated to the requesting application server. In some embodiments, the acknowledgement can be provided in a one-time uplink transmission where the grant is included in the paging data. In some embodiments, the acknowledgement can be provided by a low level signalling transmitted by the UE to inform the RAN of proper reception of the paging notification. For example, the low level signalling can be configured as a Zadoff-Chu sequence.

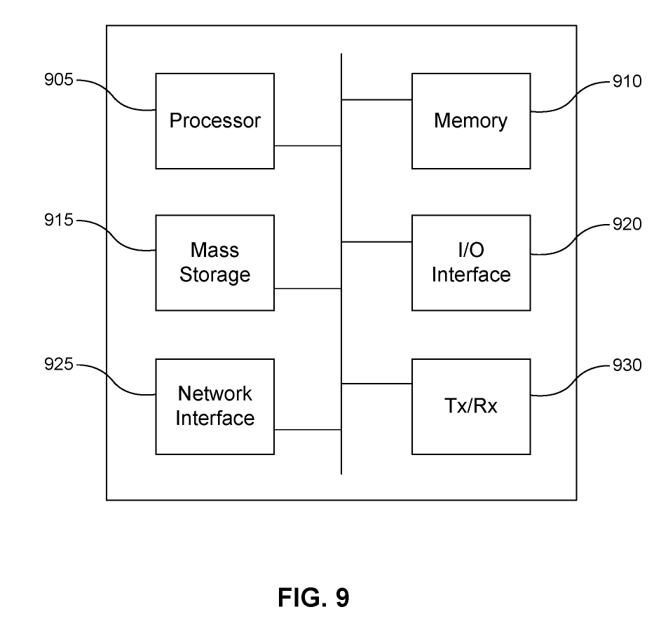

FIG. 9 is a schematic diagram of a hardware device that may for example, comprise nodes or functional entities of the communications system, or perform any or all of steps of the above methods and features described herein, according to different embodiments of the present invention. As shown, the device includes a processor 905, memory 910, non-transitory mass storage 915, I/O interface 920, network interface 925, and a transceiver 930, all of which are communicatively coupled via bi-directional bus. According to certain embodiments, any or all of the depicted elements may be utilized, or only a subset of the elements. Further, device may contain multiple instances of certain elements, such as multiple processors, memories, or transceivers. Also, elements of the hardware device may be directly coupled to other elements without the bi-directional bus.

The memory may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. According to certain embodiments, the memory or mass storage may have recorded thereon statements and instructions executable by the processor for performing any of the aforementioned method steps described above.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for paging an application operating on a User Equipment (UE), the method comprising:
transmitting, by the UE, an identifier, the identifier at least indicative of the application associated with the UE;
receiving, by the UE, a notification, the notification including data indicative of the identifier; and
determining, by the UE, that the notification is a paging notification and identifying the application associated with the identifier.

2. The method according to claim 1, wherein the paging notification includes a payload, wherein the payload is one or more of data, commands and an origin of the notification.

3. The method according to claim 1, further comprising determining if the application is operable.

4. The method according to claim 3, further comprising providing the paging notification to the application when the application is determined to be operable.

5. A user equipment (UE), comprising:
a processor; and
machine readable memory storing machine executable instructions which when executed by the processor configure the UE to:
transmit the identifier at least indicative of the application associated with the UE;
receive the notification including data indicative of the identifier; and
determine if the notification is a paging notification and identifying the application associated with the identifier when the notification is a paging notification.

6. The UE according to claim 5, wherein the paging notification includes a payload, wherein the payload is one or more of data, commands and an origin of the notification.

7. The UE according to claim 5, wherein the machine executable instructions which when executed by the processor further configure the UE to determine if the application is operable.

8. The UE according to claim 7, wherein the machine executable instructions which when executed by the processor further configure the UE to provide the paging notification to the application when the application is determined to be operable.

9. A method for paging an application operating on a User Equipment, UE, the method comprising:
receiving, by an application server, an identifier, the identifier at least indicative of the application associated with the UE;
transmitting, by the application server, a paging notification, the paging notification including data indicative of the identifier of the application.

10. The method according to claim 9, wherein the paging notification further includes data indicative of one or both of commands and data associated with the application.

11. The method according to claim 9, wherein the paging notification is transmitted as a short message service (SMS) message.

12. The method according to claim 9, wherein the paging notification is transmitted to a network based locator function configured to provide contact parameters relating to the UE.

13. The method according to claim 12, wherein the network based locator function is a modified domain name server.

14. The method according to claim 12, wherein the contact parameters further relate to the application associated with the UE.

15. An application server comprising:
a processor; and
machine readable memory storing machine executable instructions which when executed by the processor configure the application server to:
receive an identifier, the identifier at least indicative of the application associated with the UE;
transmit a paging notification, the paging notification including data indicative of the identifier.

16. The application server according to claim 15, wherein the paging notification further includes data indicative of one or both of commands and data associated with the application.

17. The application server according to claim 15, wherein the paging notification is transmitted as a short message service (SMS) message.

18. The application server according to claim 15, wherein the paging notification is transmitted to a network based locator function configured to provide contact parameters relating to the UE.

19. A method for paging an application associated with a User Equipment (UE) the method comprising:
receiving, by a network based locator function, an identifier, the identifier at least indicative of the application associated with the UE;
determining, by the network based locator function, one or more mobility managers which serve the UE, wherein determining is based at least in part on the identifier; and
transmitting, by the network based locator function, a paging request to the one or more determined mobility managers, the paging request including data indicative of the identifier.

20. The method according to claim 19, wherein the paging request includes a payload that includes one or more of data, commands and information indicative of an origin of the notification.

21. The method according to claim 19, wherein the network based locator function is a modified domain name server.

22. An network based locator function comprising:
a network interface for transmitting data to and receiving data from nodes connected to a network;
a processor; and
machine readable memory storing machine executable instructions which when executed by the processor configure the network based locator function to:
receive an identifier, the identifier at least indicative of the application associated with the UE;
determine, based at least in part on the identifier, one or more mobility managers which serve the UE; and
transmit a paging request to the one or more determined mobility managers, the paging request including data indicative of the identifier.

23. The network based locator function according to claim 22, wherein the paging request includes a payload that includes one or more of data, commands and information indicative of an origin of the notification.

24. The network based locator function according to claim 23, wherein the network based locator function is a modified domain name server.
